(19) United States
(12) Patent Application Publication
(10) Pub. No.: US 2005/0137909 A1
(43) Pub. Date: Jun. 23, 2005

(54) Medical apparatus lease system for which fees are paid depending on usage status and medical apparatus compatible therewith

(75) Inventors: Takao Tabata, Hachida-shi (JP); Junichi Onishi, Hachioji-shi (JP); Makoto Tsunakawa, Toda-shi (JP); Norihiko Hareyama, Hachioji-shi (JP); Takashi Ozaki, Hachioji-shi (JP); Satoshi Honma, Hino-shi (JP); Kazunori Taniguchi, Hachioji-shi (JP); Takeaki Nakamura, Hino-shi (JP); Yoshia Hoshino, Hachioji-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: OLYMPUS OPTICAL CO., LTD., Tokyo (JP)

(21) Appl. No.: 11/049,125

(22) Filed: Feb. 2, 2005

Related U.S. Application Data
(62) Division of application No. 09/659,771, filed on Sep. 11, 2000, now abandoned.

(30) Foreign Application Priority Data
Sep. 21, 1999 (JP) 11-266688
Aug. 25, 2000 (JP) 2000-255632

(51) Int. Cl. G06F 17/60

(52) U.S. Cl. 705/2

(57) ABSTRACT

A medical apparatus is provided which includes a usage detecting section which operates in connection with an operation of a medical device. A counting section stores a value corresponding to a number of operations of the usage detecting section.

### CROSS-REFERENCE TO RELATED APPLICATIONS

The present application is a Divisional Application of U.S. application Ser. No. 09/659,771, filed Sep. 11, 2000, which is based upon and claims the benefit of priority from the prior Japanese Patent Applications No. 11-266688, filed Sep. 21, 1999; and No. 2000-255632, filed Aug. 25, 2000, the entire contents of which are incorporated herein by reference.

### BACKGROUND OF THE INVENTION

The present invention relates to a medical apparatus lease system and a medical apparatus compatible with this medical apparatus lease system.

Jpn. Pat. Appln. KOKAI Publications No. 5-49647 and 8-164145 disclose information on the life cycle of a medical apparatus and on the needs for maintenance as well as a technique for monitoring the functional status of the medical apparatus.

There are many medical apparatus lease companies that lease medical apparatuses to medical facilities; lease fees are paid depending on how many times the medical apparatus has been used or on the amount of time for which the medical apparatus has been leased.

On the other hand, a method of maintenance for an apparatus has been proposed. For example, Jpn. Pat. Appln. KOKAI Publication No. 10-177325 discloses a management system for storing information on errors that have occurred in a product. Jpn. Pat. Appln. KOKAI Publication No. 10-222568 also discloses a system for managing a product by storing individual information on the product and the history of repairs.

Jpn. Pat. Appln. KOKAI Publications No. 5-49647 and 8-164145, however, requires a medical apparatus user or a maintenance staff member to directly read monitored information from the medical apparatus if a functional or operational error has occurred in the medical apparatus. Thus, whenever the medical apparatus is found to have a safety problem, a medical apparatus user such as a doctor or a nurse who has noticed the problem, or a maintenance staff member in the hospital must communicate with the medical apparatus manufacturer or distributor. This requires a large amount of time and labor.

In addition, if the medical apparatus becomes defective and can no longer used, the medical apparatus lease company is asked for a monetary compensation such as a reduction in the lease fees. This is disadvantageous to the operation of the lease business.

A medical apparatus lease company that leases a medical apparatus to a medical facility and charges lease fees depending on the number of times that the medical apparatus has been used or the amount of time for which the equipment has been used must visit the medical facility using the equipment to check the number of previous operations. Disadvantageously, these visits require a large amount of time and a high labor cost.

Furthermore, the apparatus described in Jpn. Pat. Appln. KOKAI Publication No. 10-177325 stores only set values or a usage status when an error occurs in the product but not information such as the number of times that the equipment has been operated before the error occurred. In addition, although Jpn. Pat. Appln. KOKAI Publication No. 10-222568 stores the history of repairs, no action can be taken for a possible failure depending on the length of time that has passed since the last repair or the number of times that the equipment has been operated since the last repair. Neither of these applications shows how many times a treatment instrument has been used, so that it may be difficult to definitely determine when to replace the instrument, resulting in a trouble. It is uneconomical to replace, for safety, the medical apparatus long before its life is over. Therefore, none of the conventional medical apparatus is compatible with the medical apparatus lease system.

### BRIEF SUMMARY OF THE INVENTION

It is a first object of the present invention to provide a medical apparatus lease system that enables a medical apparatus lease company to analyze and understand the usage status of a medical apparatus or a problem therewith and to determine lease fees depending on how and how many times the medical apparatus has been used.

It is a second object of the present invention to provide a medical apparatus compatible with a medical apparatus system which can reduce possible troubles by storing the number of times that a treatment instrument has been used in order to allow a user to determine when a specified number of usage has been reached and to check the number of previous usage to replace the treatment instrument with a new product as required.

To attain the first object, a first aspect of the present invention is a medical apparatus lease system comprising:
an input section for inputting information on a usage status of a medical apparatus;
a storage section for storing information on the usage status of the medical apparatus as electronic data;
a transmission section for transmitting the electronic data on the usage status stored in the storage section;
a fee system holding system for holding fee systems that set lease fees for the medical apparatus;
a calculation section for calculating the amount of lease fees for the medical apparatus by correlating the electronic data on the usage status of the medical apparatus to the fee systems held by the fee system holding system; and
a billing information creating section for creating billing information for charging the amount of lease fees calculated by the calculation section to a preset payer of the lease fees for the medical apparatus.

A second aspect of the present invention is a medical apparatus lease method comprising:
an input step of inputting information on a usage status of a medical apparatus;
a storage step of storing information on the usage status of the medical apparatus as electronic data;
a transmission step of transmitting the stored electronic data on the usage status;
a calculation step of calculating the amount of lease fees for the medical apparatus by correlating the electronic data on the usage status to the fee system held by the fee system holding system;
a billing information creating step of creating billing information required to charge the amount of lease fees calculated by the calculation step to a preset payer of the lease fees for the medical apparatus; and
a billing step of providing the fee payer with the billing information created by the billing information creating section.

A third aspect of the present invention is a medical apparatus comprising:
a usage detecting section operating in connection with usage of a medical apparatus; and
a count section for holding a value proportional with a quantity of usage of the usage detecting section.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a conceptual drawing of the entire configuration of a medical apparatus lease system according to a first embodiment of the present invention;

FIG. 2 is part of a flow chart of the entire medical apparatus lease system according to the first embodiment;

FIG. 3 is part of a flow chart of the entire medical apparatus lease system according to the first embodiment;

FIG. 4 is part of a flow chart of a medical apparatus according to the first embodiment;

FIG. 5 is part of a flow chart of the medical apparatus according to the first embodiment;

FIG. 6 is a table showing types of fee systems for the medical apparatus lease system according to the first embodiment;

FIG. 7 is a diagram showing an example of screen displays on a terminal at a hospital according to the first embodiment;

FIG. 8 is a diagram showing an example of screen displays on the terminal at the hospital according to the first embodiment;

FIG. 9 is a diagram showing an example of screen displays on a terminal of a medical apparatus supplier according to the first embodiment;

FIG. 10 is a diagram showing an example of screen displays on the terminal of the medical apparatus supplier according to the first embodiment;

FIGS. 11A and 11B show examples of client, equipment, lease condition input screen displays;

FIG. 12 is a side view of an ultrasonic coagulation incision treatment instrument of a medical apparatus system according to a second embodiment;

FIG. 13 is a view useful in explaining an experience-on-usage storage function section of the ultrasonic coagulation incision treatment instrument;

FIG. 14 is a side view of an ultrasonic coagulation incision treatment instrument of a medical apparatus system according to a first variation of the second embodiment;

FIG. 15 is a view useful in explaining an experience-on-usage storage function section of the ultrasonic coagulation incision treatment instrument;

FIG. 16 is an enlarged view of a grip section of a high-frequency treatment instrument according to a second variation of the second embodiment;

FIG. 17 is a view useful in explaining a high-frequency treatment instrument according to a third variation of the second embodiment;

FIG. 18 is a view useful in explaining a high-frequency treatment instrument according to a fourth variation of the second embodiment;

FIG. 19 is a view useful in explaining a high-frequency treatment instrument according to a fifth variation of the second embodiment;

FIG. 20 is a view useful in explaining a neighborhood of a connection between a high-frequency treatment instrument and a device main body;

FIG. 21 is a block diagram of a device main body of a high-frequency treatment system according to the fifth variation of the second embodiment;

FIG. 22 is a view useful in explaining a system according to a sixth variation of the second embodiment;

FIG. 23 is a view useful in explaining a system according to a seventh variation of the second embodiment;

FIG. 24 is a view useful in explaining a system according to an eighth variation of the second embodiment; and

FIG. 25 is a view useful in explaining a system according to a ninth variation of the second embodiment.

### DETAILED DESCRIPTION OF THE INVENTION

### First Embodiment

(Configuration)

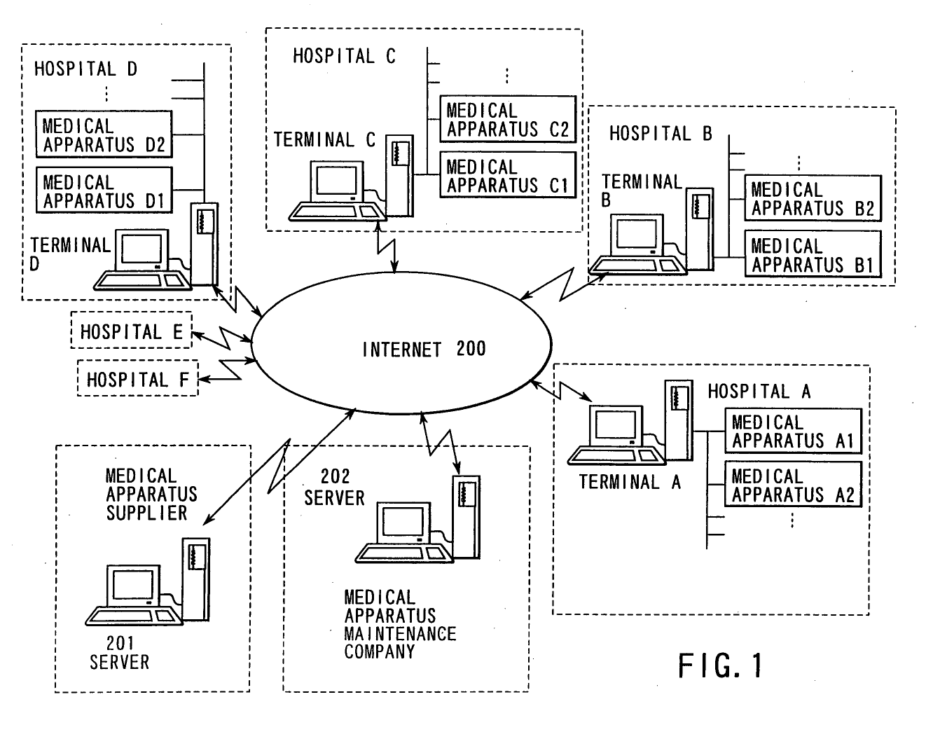

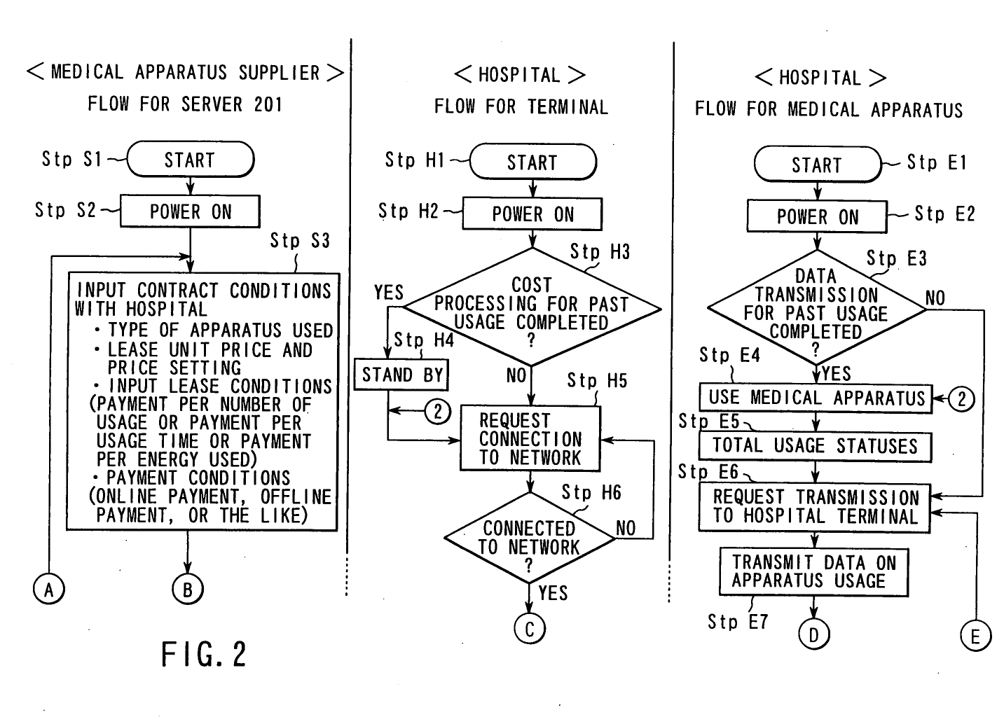

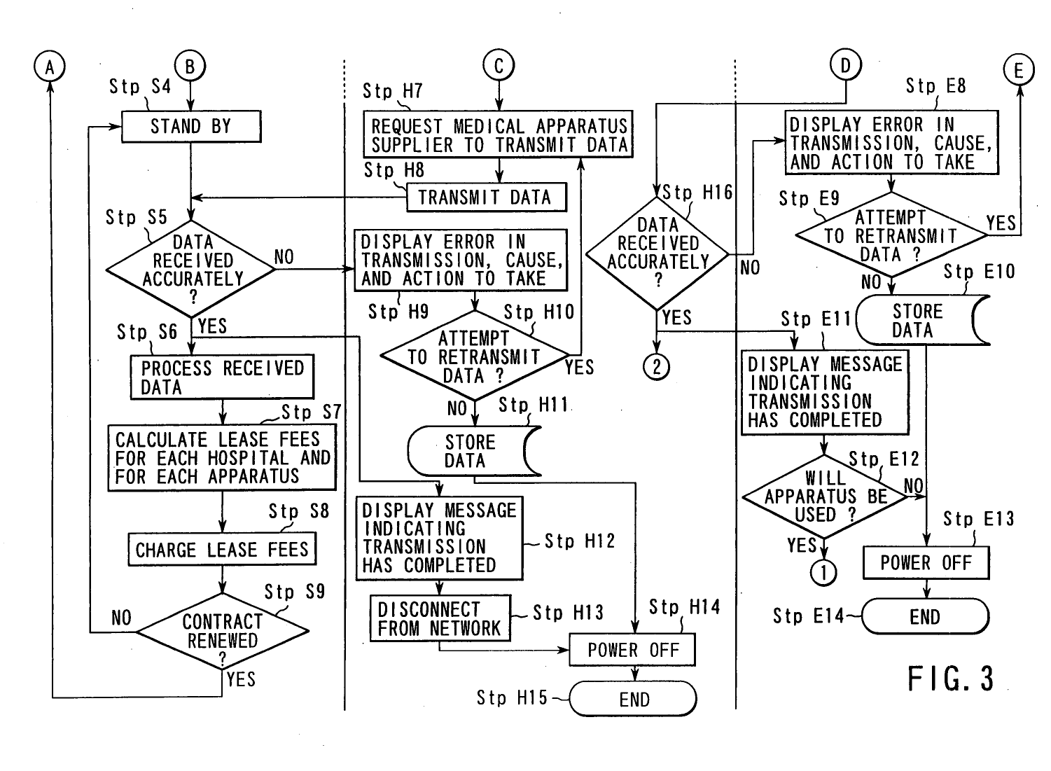

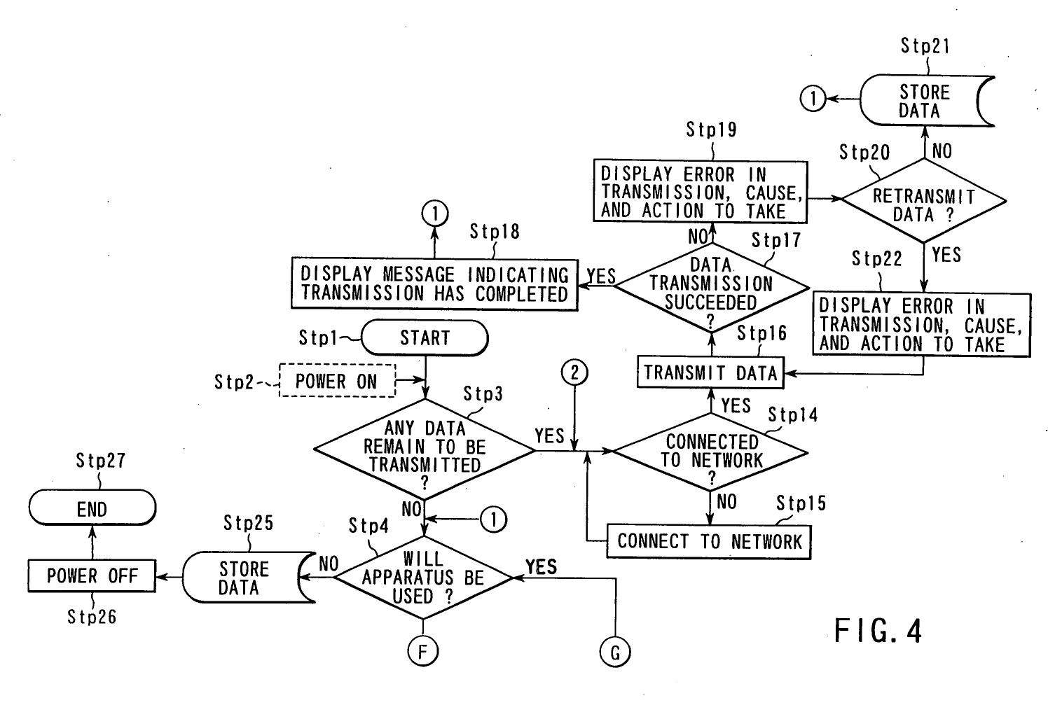

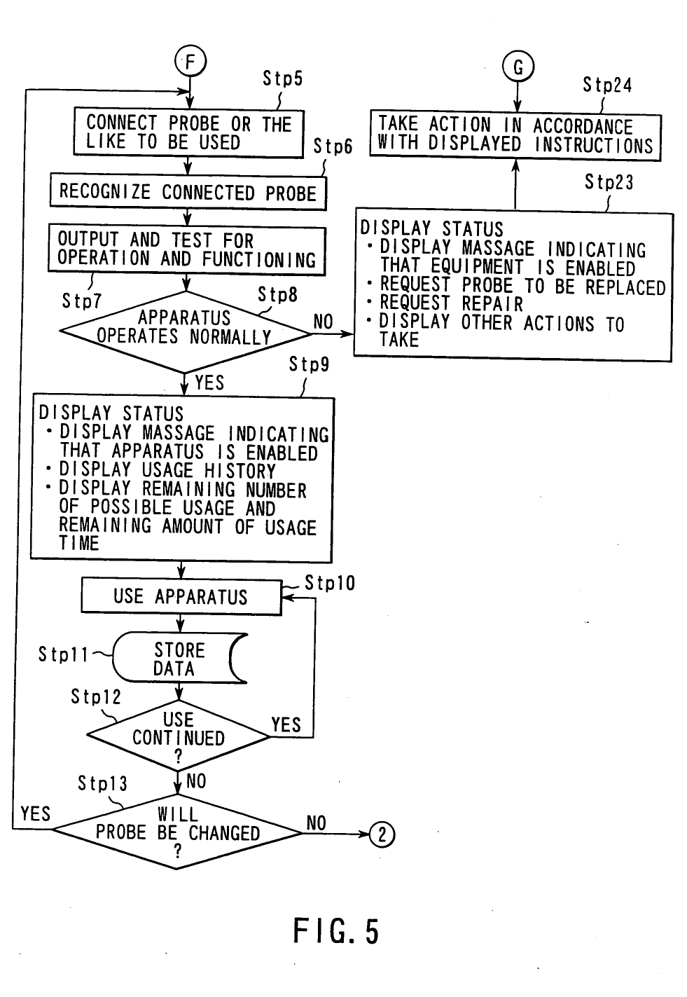

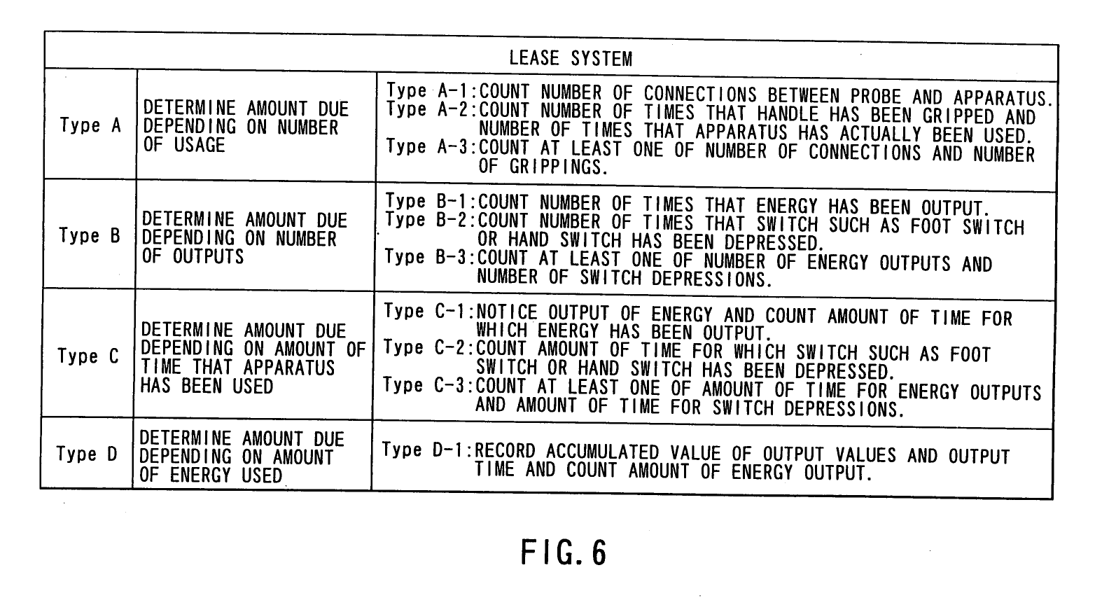

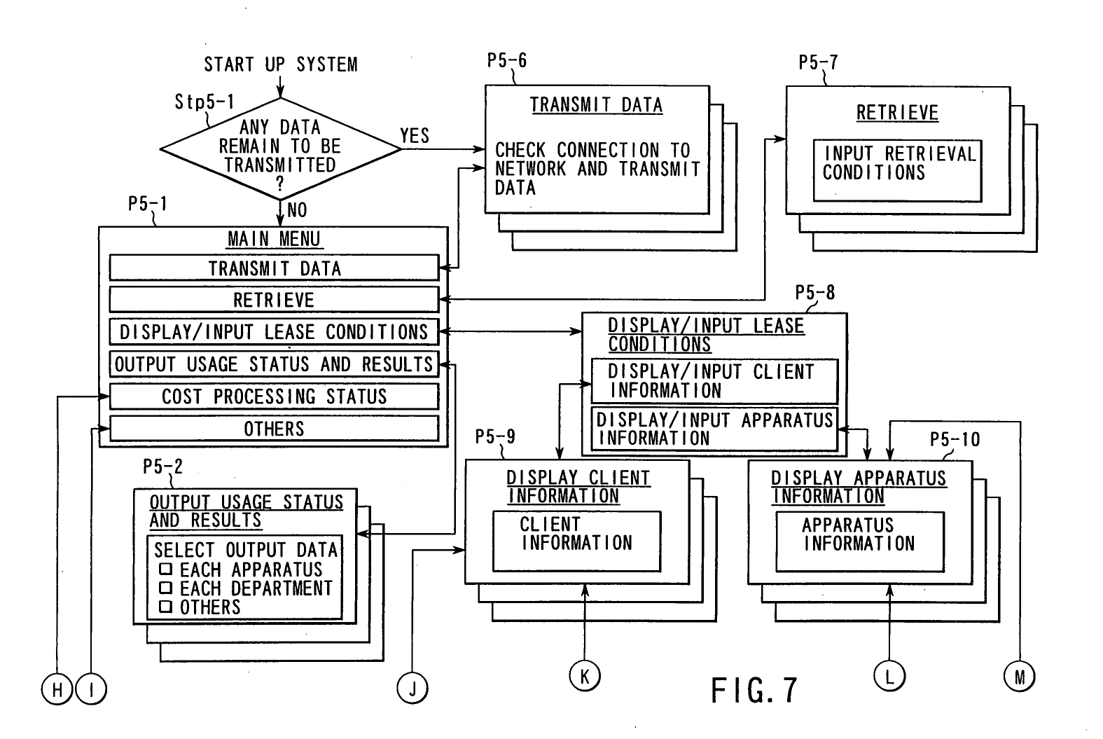

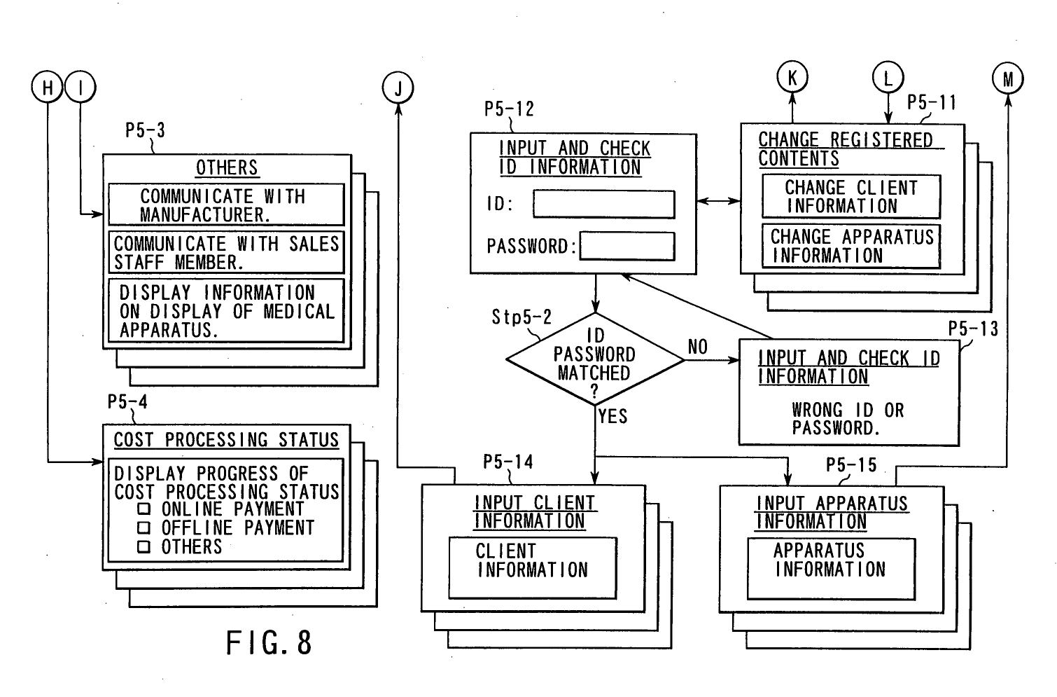

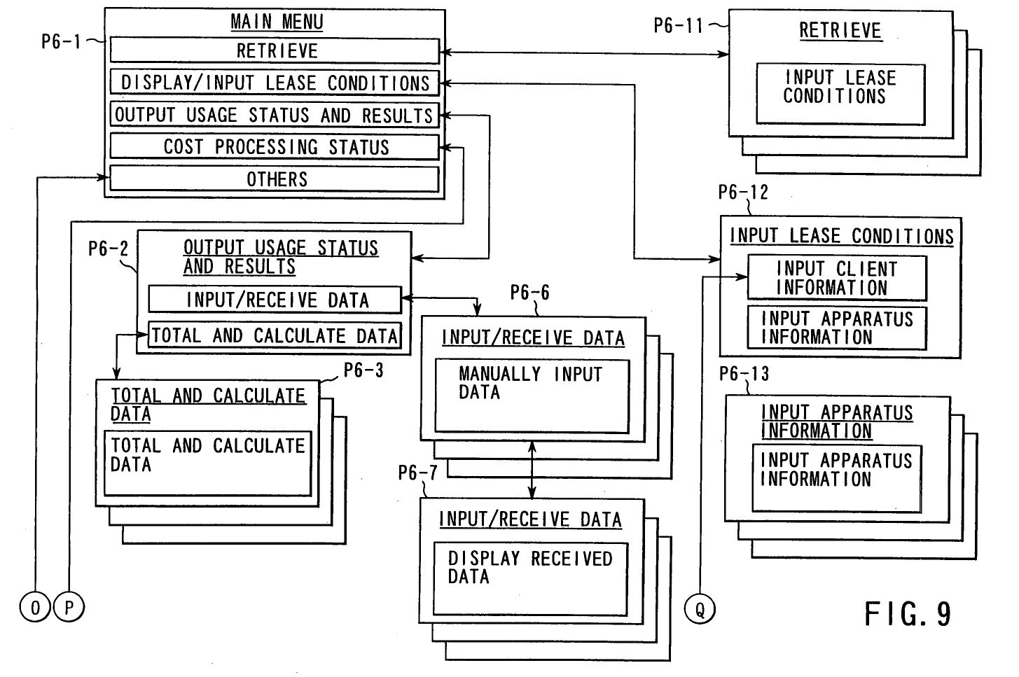

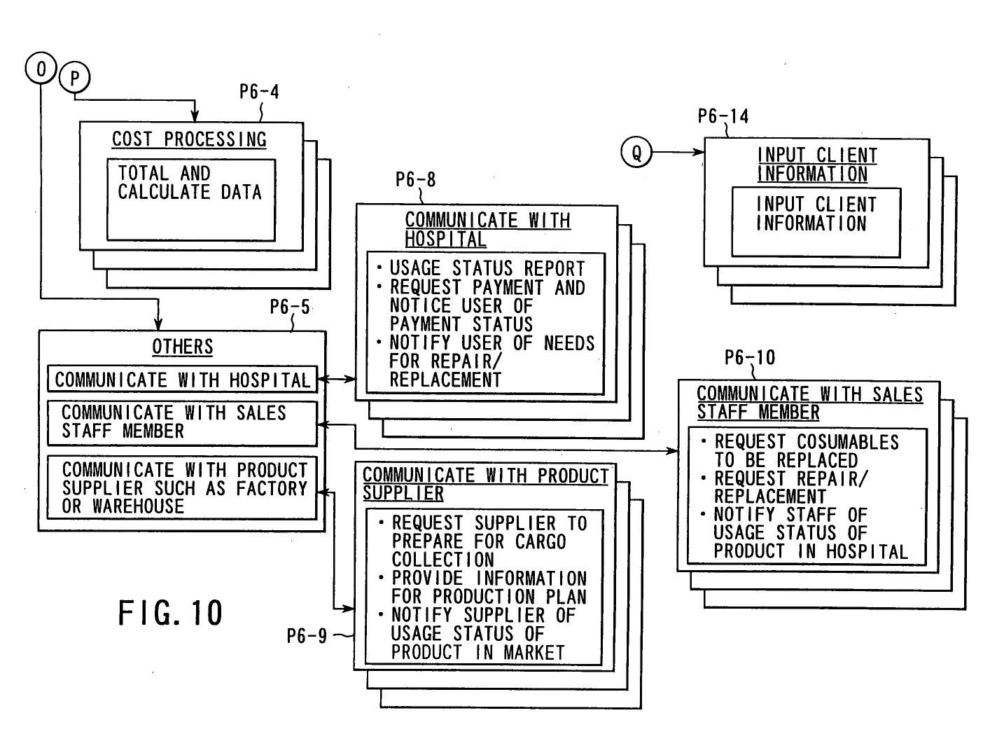

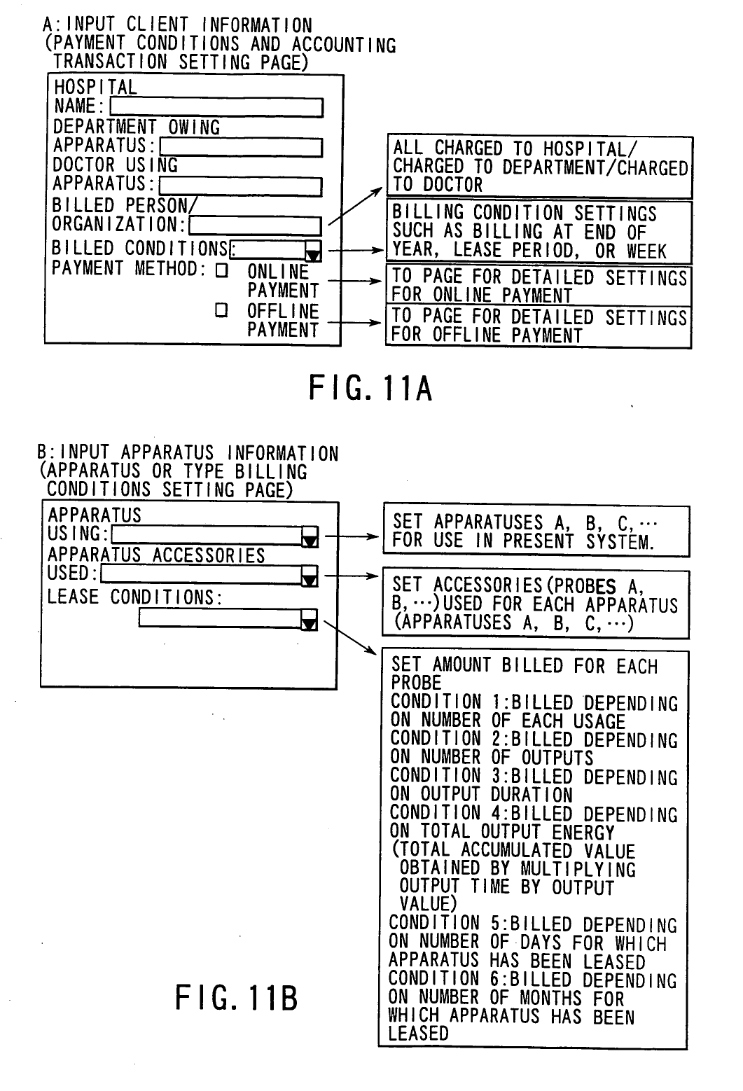

FIG. 1 shows a conceptual drawing of the entire configuration of a medical apparatus lease system according to a first embodiment of the present invention. FIGS. 2 and 3 show a flow chart of the entire medical apparatus lease system according to the first embodiment. FIGS. 4 and 5 show a flow chart of a medical apparatus according to the first embodiment. FIG. 6 shows types of fee systems for the medical apparatus lease system according to the first embodiment. FIGS. 7 and 8 show examples of screen displays on a terminal at a hospital according to the first embodiment. FIGS. 9 and 10 show examples of screen displays on a terminal of a medical apparatus supplier according to the first embodiment. FIGS. 11A and 11B show examples of client, equipment, lease condition input screen displays.

First, the entire configuration of a medical apparatus lease system according to a first embodiment will be explained with reference to FIG. 1.

A medical apparatus A1, a medical apparatus A2, and a plurality of medical apparatus (not shown) which are installed in a hospital A and operated by the present system are connected to a terminal A via a communication network within the hospital. Likewise, a plurality of medical apparatuses used in a hospital B or a plurality of other hospitals and operated by the present system are each connected to a terminal at the hospital via a network within the hospital. Then, the terminal A at the hospital A and the terminals at the other hospitals can be connected to a server 201 operated by a medical apparatus supplier via a communication network, for example, a network such as the Internet 200. Furthermore, the communication network, for example, a network such as the Internet 200 has a server 202 communicably connected thereto and operated by a medical apparatus maintenance company, a sales staff member (not shown), or the like.

With this configuration, electronic information sent from the medical equipment used in each hospital can be transmitted to the corresponding terminal device via the corresponding in-hospital communication network, so that the electronic information sent to the terminal device from the medical apparatus can be communicated to the server 201 operated by the medical apparatus supplier via the communication network, for example, a network such as the Internet 200. In contrary, electronic information sent from the server 201 operated by the medical apparatus supplier can be communicated to the terminal device at the hospital via the communication network, for example, a network such as the Internet 200, or electronic information can be communicated from the terminal device at each hospital to each medical apparatus via the in-hospital communication network.

Similarly, the server 202 can communicate electronic information from the medical apparatus maintenance company or the sales staff member (not shown) to each hospital or the medical apparatus supplier via the communication network, for example, a network such as the Internet 200.

(Operation)

The relationship between flows for the medical apparatus, the hospital terminal, and the medical apparatus supplier will be described with reference to the flow chart in FIGS. 2 and 3.

First, the flow for the server 201 at the medical apparatus supplier will be explained.

At Stp S1 (Stp represents a step) and Stp S2, the server 201 is powered on to start up the system. At Stp S3, conditions for a lease contract are input. The contents of the input include information on a client such as a contracted hospital and the name of the doctor, the type of a medical apparatus used, the unit price of and usage conditions for the medical apparatus, and conditions based on the lease contract such as an online payment or an offline payment. Furthermore, a sales staff member, a maintenance company in that district, and other information can be input.

For the unit price and usage conditions, fee systems such as those shown in FIG. 6 are set, including a Type A, a “fee system with which the amount due is determined depending on the number of times that the apparatus has been operated”, a Type B, a “fee system with which the amount due is determined depending on the number of outputs”, a Type C, a “fee system with which the amount due is determined depending on the amount of time for which the apparatus has been operated”, and a Type D, a “fee system with which the amount due is determined depending on the amount of energy used”.

Moreover, the Type A allows selection of detailed conditions including a Type A-1, a “method for counting the number of times that a probe has been connected to the apparatus”, a Type A-2, a “method for counting the number of times that a handle has been gripped and the number of times that the apparatus has actually been operated”, and a Type A-3, a “method for counting at least one of the number of connection times and the number of gripping times”. The Type B allows selection of detailed conditions including a Type B-1, a “method for counting the number of times that energy has been output”, a Type B-2, a “method for counting the number of times that a switch such as a foot switch or a hand switch has been depressed”, and a Type B-3, a “method for counting at least one of the number of energy outputs and the number of switch depressions”. The Type C allows selection of detailed conditions including a Type C-1, a “method for noticing output of energy and counting the amount of time for which energy has been output”, a Type C-2, a “method for counting the amount of time for which the switch such as the foot switch or the hand switch has been depressed”, and a Type C-3, a “method for counting at least one of the amount of time for energy outputs and the amount of time for switch depressions”. The Type D allows selection of a detailed condition, that is, a Type D-1, “a method for recording an accumulated value of an output value and an output duration and counting the amount of energy output”. These conditions are input based on a contract with the medical apparatus used.

Once all conditions for the lease of the apparatus have been input, the process stand by at Stp S4 until data on the use of the apparatus is transmitted. When data from the apparatus is received, a data reception status is checked at Stp S5. If there is a problem with the data reception, it is communicated to the hospital terminal. If there is no problem with the data reception, the hospital terminal is notified of the correct reception and the server simultaneously processes the received data (Stp S6) to identify the hospital and the apparatus and calculate the number of times that this apparatus has been used (Stp S7). Based on the data calculated at Stp S7, the server charges lease fees to a medical facility such as the hospital at the end of a month or a contracted period according to contract conditions (Stp S8).

The billing method may be online fee processing, offline money transfer, or the like based on the contract conditions. If any error is found in the apparatus when the received data are processed at Stp S6, the corresponding status may be communicated to a medical facility such as the hospital using a data communication network shown in FIG. 1 or means other than the communication network such as the Internet shown in FIG. 1, the network using telephones or electronic mails. It can be communicated to a maintenance service company in the district.

Once the billing process has been completed at Stp S8, it is determined whether or not to renew the contract with the medical apparatus user (Stp S9). If the contract is not to be renewed, the process returns to Stp S4 to enter the standby state to wait for information on the use of the apparatus from the hospital. Alternatively, if the contract with the hospital is to be renewed, the process shifts from Stp S9 to Stp S3 to renew the contents of the contract. Since the server 201 can carry out a plurality of processes in parallel, data can be received at any point of time within the above flow.

Examples of display screens of the server at the medical apparatus supplier will be explained with reference to FIGS. 9 and 10.

When the system is started up, a main menu screen P6-1 is displayed. When “Retrieve” is selected, the display shifts to a retrieval condition input screen P6-11 to retrieve various information stored in the server. Alternatively, when “Input Usage Conditions” is selected in P6-1, the display shifts to a usage-condition input screen P6-12. When an items to be input, “Client Information Input” or “Apparatus Information Input” is selected, the display shifts to an apparatus information input screen P6-13 or a client information input screen P6-14.

The details of the apparatus information input screen P6-13 and the client information input screen P6-14 are shown in FIGS. 11A and 11B. For the input of the client information, it is possible to input the names of a client hospital and a section, the name of a doctor who principally uses the apparatus, a billed person or organization, that is, the doctor, the section, the hospital, or the group of affiliated hospitals as shown in FIG. 11A. Billing conditions can be set in accordance with the contract conditions; that is, the fees can be paid at the end of the contracted period or at the end of every month or week. The details of the payment can also be set depending on the form of the hospital, that is, an online or offline payment. For the input of the apparatus information, it is possible to input the apparatus used, a probe or the like which is connected to the apparatus for operation, conditions based on the various fee systems shown in FIG. 6, as shown in FIG. 11B.

When “Output Usage Status and Results” is selected in a main menu screen P6-1, shown in FIGS. 9 and 10, the display proceeds to a screen for totaling and displaying data stored in the server at the medical apparatus supplier (P6-3), a screen for allowing the usage status of the apparatus to be manually input (P6-6), or a screen for showing a reception status (P6-7). Alternatively, when “Cost Processing” is selected in the main menu screen P6-1 shown in FIGS. 9 and 10, the display shifts to a screen for allowing a past payment status, the current lease fees, or the like to be totaled and calculated (P6-4). When “Others” is selected in the main menu screen P6-1 shown in FIGS. 9 and 10, the display proceeds to a screen for enabling communications with the hospital (P6-8), including a report on the fees for the apparatus, a request for the payment of the fees, and the notification of the needs for the replacement of consumables and for the repair of the apparatus, a screen for notifying the sales staff member of the replacement or repair of consumables, the usage status of the apparatus in the hospital, or the like (P6-10), or a screen for notifying the manufacturer of a consumption status of consumables in the market or providing the manufacturer with information for a manufacturing plan for the factory based on the consumption status and information on the operation or quality of the apparatus in the market (P6-9).

Subsequently, the flow for the hospital terminal will be explained with reference to FIGS. 2 and 3.

When the hospital terminal is started up at Stp H1 and Stp H2, it is determined that data transmitted from the medical apparatus described later has already been processed (Stp H3). If the received data have already been processed, the process waits for data from the medical apparatus to be received (Stp H4). If data has been received from the apparatus or it is determined at Stp H3 that the received data have not been processed yet, the hospital terminal is requested to connect to a network, for example, the Internet via which the terminal is connected to the server 201 at the medical apparatus supplier (Stp H5). If the connection to the network is not completed (Stp H6), the hospital terminal is requested again to connect to the network (Stp H5). Once the connection to the network has been completed, the hospital terminal is requested to transmit data from the medical apparatus to the server 201 at the medical supplier 201 (Stp H7), and the data are transmitted (Stp H8).

If the server 201 at the medical apparatus supplier was unable to receive data accurately, the cause of the transmission failure and possible action to take are transmitted to the hospital terminal in addition to the message indicating the failure (Stp H9). If the hospital terminal attempts to retransmit the data, the process returns to Stp H7. If, however, the hospital terminal does not attempt to retransmit the data, it can store the data (Stp H11) and end the system (Stp H14 and Stp H15).

If the transmission to the server 201 at the medical apparatus supplier has been completed, a message is displayed indicating that the transmission has been completed (Stp H12) and the hospital terminal can clear the connection with the network (Stp h13) to end the system (Stp H14 and Stp H15). Since the terminal can carry out a plurality of processes in parallel, data can be received at any point of time within the above flow.

Examples of display screens of the hospital terminal will be explained with reference to FIGS. 7 and 8.

When the terminal is started up and if any data remains to be transmitted (Stp 5-1), the display shifts to a data transmission screen (P5-6) to transmit the data. If all the data have been transmitted (Stp 5-1), the display shifts to the main menu screen (P5-1) to further transfer to “Transmit Data”, “Retrieve”, “Display/Input Usage Conditions”, “Output Usage Status and Results”, “Cost Processing Status”, or “Others”.

When “Transmit Data”, is selected in the main menu screen (P5-1), the display shifts to a data transmission screen to allow a data transmission operation to be performed. When “Retrieval” is selected in the main menu screen (P5-1), the display shifts to a display/input usage conditions screen (P5-8) to allow “Display/Input Client Information” or “Display/Input Apparatus Information” to be selected. When “Display/Input Client Information” is selected, the current client information is displayed (P5-9), and when “Display/Input Apparatus Information” is selected, the current apparatus information is displayed (P5-10). To change already input information, the display shifts to a “Change Registered Screen” screen (P5-11), but to preclude an outsider from rewriting the data, an ID and a password are input in an “Input and Check ID Information” screen (P5-12) so that if the ID and password are correct (Stp 5-2), the display can shift to an “Input Client Information” screen (P5-14) or an “Input Apparatus Information” screen (P5-15) to allow the corresponding information to be input or modified. Once the corresponding information has been input or modified, the display shifts to a “Display Client Information” screen (P5-9) or a “Display Apparatus Information” screen (P5-10) to display the latest input information. If the ID or password is incorrect (Stp 5-2), a message is displayed indicating that the ID or password is incorrect (P5-15) and asking an ID and a password to be input again (P5-12). The display cannot shift to the “Input Client Information” screen (P5-14) or the “Input Apparatus Information” screen (P5-15) as long as the incorrect ID or password is input (Stp 5-2).

When the “Output Usage Status and Results” is selected in the main menu screen (P5-1), the display shifts to a screen for retrieving and outputting the usage status of the medical apparatus (P5-3). When “Cost Processing Status” is selected in the main menu screen (P5-1), it can be checked how the lease fees have been paid to the medical apparatus supplier (P5-4) even if the fees are paid online. When “Others” is selected in the main menu screen (P5-1), “Communicate with Manufacturer” may be selected to ask the manufacturer for a repair or an inspection, or “Communicate with Sales Staff” may be selected to order consumables, or “Display Information on Medical Apparatus” may be selected to communicate a message “Consumables Ordered” to a doctor or nurse who actually use the medical apparatus.

Subsequently, the flow for the medical apparatus at the hospital will be explained.

When the medical apparatus is started up (Stp E1 and Stp E2), it is checked whether or not the medical apparatus transmitted data when previously operated (Stp E3). If the data transmission has been completed, the medical apparatus is operated (Stp E4) and results of the operation are totaled (Stp E5). If it is determined at Stp E3 that the data transmission has not been completed, when all the results of the operation have been totaled at Stp E5, the medical apparatus is requested to connect to the hospital terminal (Stp E6) and then transmits data on its own operation to the hospital terminal (Stp E7). If an error has occurred during the data transmission, a message is displayed indicating that the transmission has failed as well as the cause of the failure and action to take (Stp E8). When the medical apparatus attempts to retransmit the data (Stp E9), the process returns to Stp E6, where the medical apparatus connects to the hospital terminal before retransmitting the data. Alternatively, if the medical apparatus does not attempt to retransmit the data, the process proceeds to Stp E10, where data on the operations of the medical apparatus are stored and the operation of the medical apparatus is ended (Stp E13 and Stp E14).

Alternatively, if the data has been smoothly transmitted to the hospital terminal, a message is displayed indicating that the transmission has been completed (Stp E11). To repeat operating the medical apparatus (Stp E12), the process returns to Stp E4 to operate the medical apparatus again. If the operation of the medical apparatus is not to be repeated, the process proceeds to Stp E13 and Stp E14 to complete the use of the medical apparatus.

FIGS. 4 and 5 show the flow for the medical apparatus at the hospital in further detail in terms of detection of a probe used in combination with the medical apparatus. When the medical apparatus is started up at Stp1 and Stp2, it is checked whether or not all the data have been transmitted (Stp3). If any data remains to be transmitted, it is checked whether the medical apparatus is connected to the network (Stp14). If the apparatus is not connected to the network, it connects to the network (Stp15) to transmit the data (Stp16). If the data have been reliably transmitted (Stp17), a message is displayed indicating that the transmission has been completed (Stp18) and the process shifts to a step at which the medical apparatus is operated.

Alternatively, if an error has occurred during the data transmission (Stp17), message is displayed indicating that the transmission has failed as well as the cause of the failure and action to take (Stp19). When the medical apparatus attempts to retransmit the data (Stp20), action is taken against the transmission error (Stp22) before shifting to a data transmission (Stp16). Alternatively, if the medical apparatus does not attempt to retransmit the data, the data are stored (Stp21) and the process shifts to a step at which the medical apparatus is operated.

If the medical apparatus is not to be operated (Stp4), data on the last usage conditions are stored (Stp25) to complete the use of the medical apparatus (Stp26 and Stp27). If the medical apparatus is to be operated (Stp4), a probe or the like which is used in combination with the medical apparatus is connected thereto (Stp5). The probe, as used herein, refers to a general medical device connected to an enclosure section, for example, a probe for an electric scalpel, an ultrasonic coagulation incision probe for an ultrasonic coagulation incision device, or an endoscope for an endoscope drive device is used.

When the probe to be used is connected at Stp5, detection of the connected probe is recognized (Stp6). Data for recognition of detection of the probe (St6) are used to, for example, select a lease fee system that varies depending on the probe used as shown in FIG. 6 or to make determinations if the probe has a characteristic, for example, durability that varies depending on the probe used. After the recognition of the probe (St6) has been completed, the operation and functioning of the probe are detected (St7). The detection of the operation and functioning of the probe means that the probe is operated to actually output data to check the operation of the apparatus in order to ascertain whether the probe functions correctly. This is implemented using an operation checking circuit provided in the apparatus; the operation of the probe is also visually inspected.

Additionally, when the client selects a fee system beforehand, a setting is input which corresponds to the condition that, for example, “up to three energy outputs required to detect the operation and functioning are not converted into fees”, so that the medical apparatus user can carry out operation checks without increasing the fees if the user executes a specified or smaller number of operation checks for a specified or shorter amount of time using a specified or smaller amount of energy. After the probe has been checked for operation and functioning at Stp7, it is determined whether the apparatus operates correctly (STp8). If there is a problem with the operation of the apparatus, for example, the apparatus cannot be used, the probe cannot be commanded, the apparatus or the probe must be repaired, or another action must be taken, a message is displayed at Stp23 indicating that the apparatus operates incorrectly as well as action to take. Then, required action is taken (Stp24) and the user is requested to determine whether to operate apparatus again (Stp4). If there is a problem with the operation of the apparatus, Stp4, Stp5, Stp6, Stp7, Stp8, Stp23, and Stp24 are repeated so that the medical apparatus cannot be used until the problem with the operation of the apparatus has been solved. If the apparatus operates correctly, the process shifts from Stp8 to Stp9 where the status is displayed. At Stp9, the display shows how the medical apparatus has recognized the probe, for example, the type of the connected probe, the number of times that the probe has been used, the number of times that the probe can be used before its life expectancy, so that the contents of automatic determinations made by the medical apparatus can be checked against the recognition of the medical apparatus user. Once the medical apparatus user has determined to operate the medical apparatus, the process shifts to the operation of the apparatus (Stp10). The data on the usage status of the apparatus are stored in the medical apparatus each time it has been operated (Stp11). If the apparatus is continuously used (Stp12), Stp10 and Stp11 are carried out to monitor how the medical apparatus is operated, so that data on the usage status is stored (Stp11).

Further, when the probe has finished its life expectancy and is replaced with another (Stp13), once the new probe has been connected (Stp5), the process is repeated starting with the recognition of the newly connected probe (Spt6). Alternatively, when the operation is ended without using the new probe (Stp13), the process shifts to the check on the connection to the network (Stp14) and then passes through Stp14, Stp15, Stp16, Stp17, Stp18, Stp19, Stp20, Stp21, and Stp22. After a data transmission, Stp4, Stp25, Stp26, and Stp27 are carried out to complete the use of the medical apparatus.

As described above, by following the flows for the medical equipment at the hospital, the terminal at the hospital, and the sever 201 at the medical apparatus supplier, the data on the operation of the medical apparatus can be communicated between the medical equipment at the hospital and the terminal at the hospital and the sever 201 at the medical apparatus supplier.

With the above described configuration, the medical apparatus lease company can easily and appropriately analyze and understand the usage status of the medical apparatus and problems therewith and can add up the lease fees depending on the number of times that the medical apparatus has been used or on the usage status of the medical apparatus.

The above effects will be described in further detail. The above described embodiment solves the problem with the prior art that a large amount of labor and time is required when the sales staff member visits the hospital to check the medical apparatus for the usage status to calculate the lease fees. Another unique effect of this embodiment is that the manhour and labor cost of the sales staff member can be reduced to provide a more inexpensive and efficient medical apparatus lease system, thereby reducing medical costs.

Further, although the sales or maintenance staff member conventionally visits the hospital to check the medical apparatus for operation, the medical apparatus lease system according to this embodiment enables the medical apparatus to be checked for operation without requiring the sales or maintenance staff member to visit the hospital. Consequently, as described above, the manhour and labor cost of the sales staff member can be reduced to provide a more inexpensive and efficient medical apparatus lease system, thereby reducing medical costs. Errors are immediately communicated to the medical apparatus supplier or the lease company without the needs for periodical visits of the sales or maintenance staff member to the hospital for checking the medial apparatus for operation as in the prior art. As a result, the medical apparatus can be repaired or replaced earlier.

The hospital conventionally orders consumables by constantly checking how they are consumed, but with the medical apparatus lease system, the medical apparatus supplier or the lease company manage the consumables so that they are automatically ordered from their suppliers and then delivered to the hospital by the sales staff member. This eliminates the need to check how the consumables are consumed or to order them, thereby reducing the manhour and labor cost in the hospital to diminish hospital operation costs and medical costs.

In addition, the medical apparatus supplier can order products from a maker, a factory, or the like as appropriate while monitoring the usage status of the medical apparatus. This can be reflected in a production and delivery plan of the maker or factory in a short time, thereby facilitating production planning while preventing delayed deliveries and unwanted inventories.

Additionally, since the ID and password are used to permit only the authorized people to input the client or apparatus information, outsiders are prevented from conducting unwanted data rewrites or the like to unfairly process data.

Moreover, in tentatively operating the medical apparatus to check it for operation and functioning, a program for avoiding increasing the fees enable the doctor or nurse who uses the medical apparatus to test the apparatus without the need to pay unwanted costs.

In addition, the lease fee system for the medical apparatus can be selected for each probe or medical apparatus from a program for determining the amount due depending on the number of times that the medical apparatus has been used, a program for determining the amount due depending on the number of previous outputs from the medical apparatus, a program for determining the amount due depending on the amount of time for which the medical apparatus has been used or leased, a program for determining the amount due depending on the amount of energy used by the medical apparatus. Consequently, optimum payment conditions can be selected depending on the scale of the hospital or for each treatment department.

Further, the online payment simplifies payment operations, reduces the payment period, and improves the efficiency of fund management.

The above described first embodiment provides a medical apparatus lease system with which the medical apparatus lease company can easily and appropriately analyze and understand the usage status of the medical apparatus and problems therewith and can add up the lease fees depending on the number of times that the medical apparatus has been used or on the usage status of the medical apparatus.

### Second Embodiment

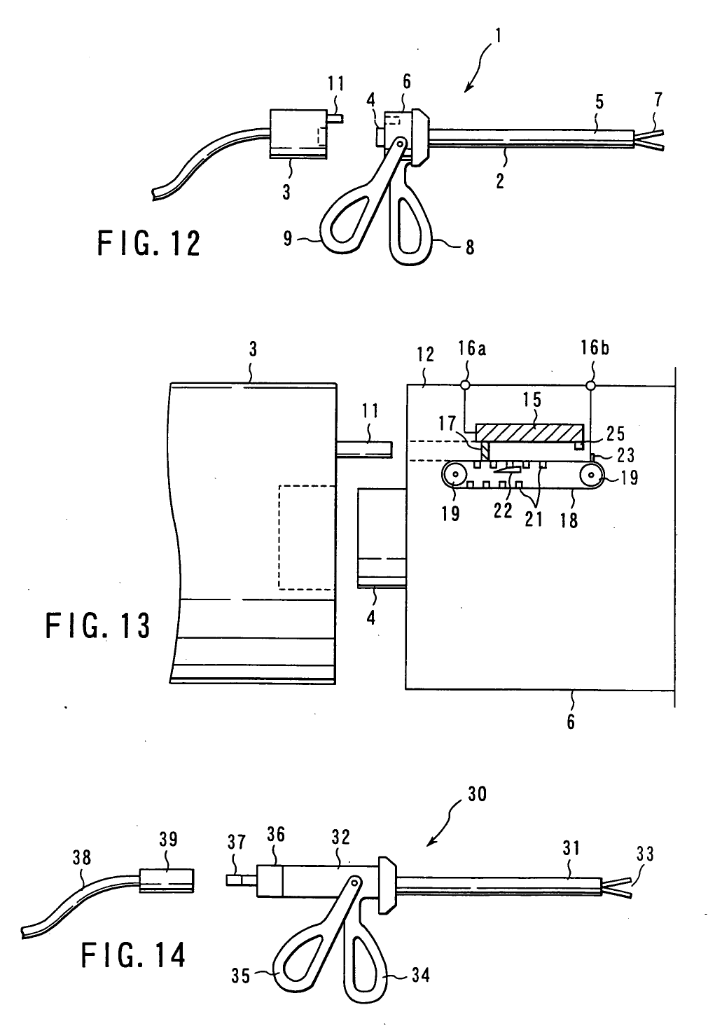

Next, a medical apparatus compatible with the above described medical apparatus lease system will be explained as a second embodiment of the present invention. An energy treatment system with an experience-on-usage storage function according to the first embodiment of the present invention will be described below with reference to FIGS. 12 and 13.

(Configuration)

FIG. 12 shows an ultrasonic coagulation and incision treatment instrument 1 for coagulation incision using ultrasonic waves as treatment energy. The ultrasonic coagulation incision treatment instrument 1 has a treatment instrument main body 2 and a vibrator unit 3. When the ultrasonic coagulation incision treatment instrument 1 is used, the treatment instrument main body 2 and the vibrator unit 3 are connected and assembled together via a connector 4 provided on the treatment instrument main body 2.

The treatment instrument main body 2 comprises a sheath 5 and a hand-held section 6. The sheath has a treatment section 7 projected from a tip thereof. The hand-held section 6 has a fixed handle 8 and a movable handle 9. The treatment section 7 is opened or closed by rotationally moving the movable handle 9.

For example, the sheath 5 is inserted into the abdominal cavity through a trocar or an endoscope to allow the treatment section 7 at the tip to grip a biological tissue in the abdominal cavity. Ultrasonic vibration is applied to the treatment section 7 to coagulate and cut the gripped biological tissue.

The vibrator unit 3 has a pin 11 which enters a connection 13 of the hand-held section 6 for connection when the treatment instrument main body 2 and the vibrator unit 3 are connected and assembled together.

FIG. 13 is a detailed view useful in explaining the internal structure of the connection 13. The connection 13 has a usage detecting section operating in connection with usage of the medical apparatus and a count section for storing an experience on usage, the usage detecting section and the count section being both integrated with the connection. That is, an electric resistor 15 is provided in this area and is made, for example, of metal such as nichrome which has a high electric resistivity. The electric resistor 15 has one end connected to one 16a of a pair of read terminals 16a and 16b. The read terminals 16a and 16b are provided along an outer periphery of a rear end of the hand-held section 6 and are connected to a read section (not shown) that is installed on the hand-held section 6.

Furthermore, a movable terminal 17 is located in an internal area of the connection 13, moves in contact with the electric resistor 15, and is attached to an outer periphery of an endless belt 18. The belt 18 is passed across a pair of pulleys 19.

The belt 18 has a plurality of stopper projections 21 arranged on an inner surface thereof in a line at intervals along a travelling direction thereof. The belt 18 has a stopper 22 located in an inner space of the belt 18 and constituting a reverse-rotation preventing mechanism that is caught on the stopper projections 21 when the belt 18 is to rotate in a reverse direction, thereby preventing the belt 18 from being reversely rotated.

The belt 18 has a metallic surface provided on a surface thereof and electrically connected to the movable terminal 17. A fixed terminal 23 fixedly installed inside the connection is always in sliding contact with the metallic surface of the belt 18. The fixed terminal 23 is connected to the read terminal 16b.

When the treatment instrument main body 2 and the vibrator unit 3 are assembled together, the pin 11 of the vibrator unit 3 advances into the internal area of the connection 13 of the treatment instrument main body 2 to come in contact with the surface of the belt 18 to frictionally rotate the belt 18 in a forward direction. That is, the belt 18 rotates by a predetermined rotational quantity each time the treatment instrument main body 2 and the vibrator unit 3 are assembled together.

The electric resistor 15 has a stopper projection 25 at its end located on the read terminal 16b side or in a neighborhood thereof, the stopper projection 25 having the movable terminal 17 coming in abutment therewith.

(Operation)

In operation, when the treatment instrument main body 2 and the vibrator unit 3 are assembled together, the pin 11 rubs against the belt 18, which is thus rotated by a fixed amount. As the belt 18 rotates, the movable terminal 17 moves rightward in FIG. 2 a fixed amount to come in contact with the electric resistor 15 at a different position, thereby changing a resistance value between the read terminal 16a and the read terminal 16b. That is, the resistance value increases as the movable terminal 17 moves. When the treatment instrument main body 2 and the vibrator unit 3 are mutually disconnected after operation, the frictional force causing the pin 111 to pull the belt 18 acts in the reverse direction, but the belt 18 is not reversely rotated because the stopper projections 21 are caught on the stopper 22.

As a result, the movable terminal 17 is held and remains at the position to which it has been moved during assembly, with the resistance value between the read terminals 16a and 16b remaining unchanged. When the assembly of the treatment instrument main body 2 and the vibrator unit 3, which is carried out before each operation, is repeated, the movable terminal 17 moves a fixed distance each time to increase the resistance value between the read terminals 16a and 16b in proportion to the number of assemblies (an experience-on-usage storage function).

Once the movable terminal 17 has reached an end point of the electric resistor 15, it comes in abutment with the projection 25 and is hindered from further movement. In this state, the resistance value between the read terminals 16a and 16b is highest. Externally reading this resistance value enables determination of the number of times that the ultrasonic coagulation incision treatment instrument 1 has been used. Consequently, the use of the ultrasonic coagulation incision treatment instrument 1 can be stopped in accordance with a safety factor.

(Effects)

According to this embodiment, the value in proportion to the number of assemblies is retained to allow the determination of the number of times that the treatment instrument has been used (experience on usage).

### First Variation of the Second Embodiment

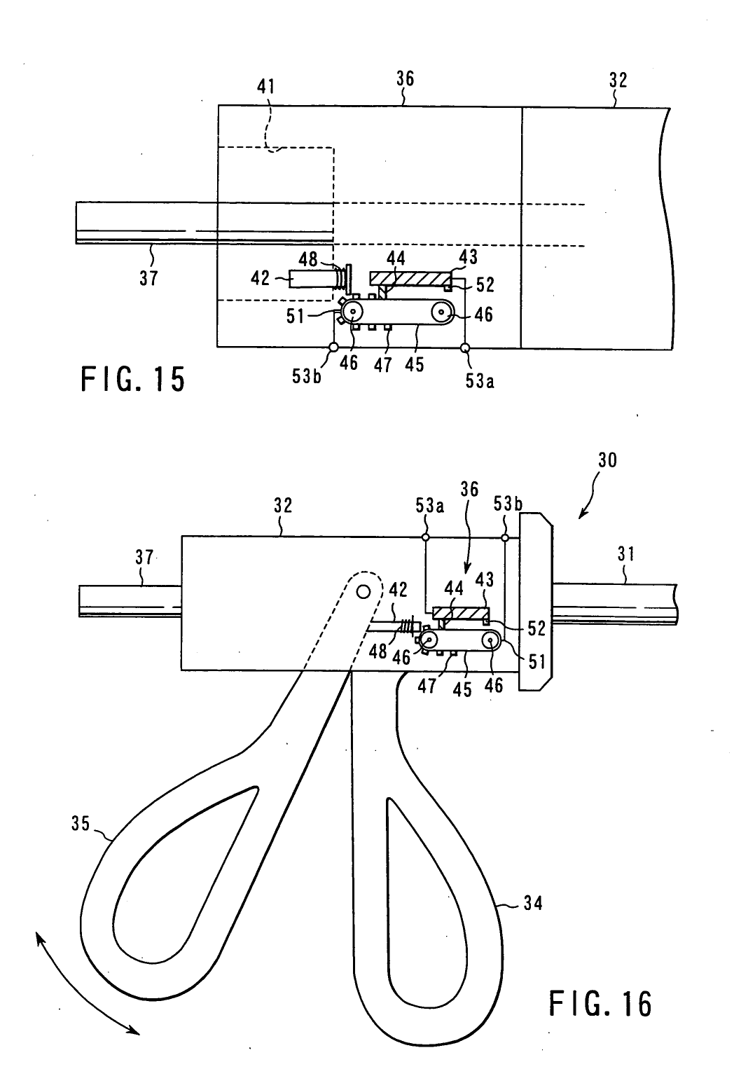

An energy treatment system with an experience-on-usage storage function according to a first variation of the second embodiment will be described with reference to FIGS. 14 and 15.

(Configuration)

FIG. 14 shows a high-frequency treatment instrument 30 such as an electric scalpel which uses a high frequency as treatment energy. The high-frequency treatment instrument 30 comprises a sheath 31 and a hand-held section 32 also acting as a grip section. The sheath 31 has a treatment section 33 provided at a tip thereof. The hand-held section 32 has a gripping handle 34 and an operation handle 35. The operation handle 35 can be rotationally moved to open or close the treatment section 33.

In addition, the hand-held section 32 has a count section 36 installed at a rear end thereof to store the experience on usage, the count section 36 comprising a usage detecting section operating in connection with usage of the apparatus. A pin-shaped high-frequency electrode 37 penetrates the count section 36 and projects rearward therefrom.

Before the high-frequency treatment instrument 30 is operated, a connector 39 of a high-frequency supply cord 36 is connected to the high-frequency electrode 37.

FIG. 15 is an explanatory drawing showing the internal structure of the count section 36 in detail. The count section 36 has a fitting recess 41 formed at a rear end thereof and into which part of the connector 39 of the high-frequency supply cord 38 advances when it is connected. The fitting recess 41 has a slidable switch operating rod 42 inside. When the connector 39 of the high-frequency supply cord 38 is connected to the high-frequency electrode 37, the switch operating rod 42 is pushed by a tip of the connector 39 and slides in a fashion entering the count section 36.

The count section 36 internally has an electric resistor 43 and a movable terminal 44 moving in contact with the electric resistor 43 and fixed to an endless belt 45. The belt 45 is passed across a pair of pulleys 46 so as to rotate in one direction, and the pulleys 46 for rotating the belt 45 can be rotated only in one direction.

The belt 45 has a plurality of projections 47 formed of an elastic material such as rubber and projected outward therefrom. The projections 47 are pushed by the switch operating rod 42 when it is pushed in, thereby rotating the belt 45. In addition, when pushed, the switch operating rod 42 returns to its original position due to a spring 48.

The belt 45 has a metallic conductive portion (not shown) formed on a surface thereof like, for example, a film and electrically connected to the movable terminal 44 and also has a fixed terminal 51 that always contacts with a surface of the conductive portion even when the belt 45 rotates.

The electric resistor 43 has a stopper projection 52 at an inner end thereof, with which the movable terminal 44 comes in abutment. The inner end of the electric resistor 43 is connected to a read terminal 53a. Another read terminal 53b is connected to the fixed terminal 51.

The read terminals 53a and 53b are provided along an outer periphery of the count section 36 and connected to a read section (not shown) installed in the count section 36.

(Operation)

Before the high-frequency treatment section 30 is operated, when the connector 39 of the high-frequency supply cord is connected, the connector 39 pushes the switch operating rod 42. At this point of time, an inner end of the switch operating rod 42 is caught on the projections 47 on the belt 45 to push them to rotate the belt 45. The rotation of the belt 45 moves the movable terminal 44 rightward in FIG. 15. Then, the resistance value between the read terminals 53a and 53b decreases consistently with the amount that the movable terminal 44 has moved.

After the use, when the connector of the high-frequency cord 38 is removed from the high-frequency electrode 37 of the high-frequency treatment instrument 30, the spring 48 causes the switch operating rod 42 to return but the belt 45 does not move because the end of the operating rod 42 only slides on the projections 47 though it is temporarily caught thereon, thereby preventing the reverse rotation of the pulleys 46. As a result, the removable terminal 44 is held at the position to which it was moved when the high-frequency supply cord 38 was connected, with the resistance value between the read terminals 53a and 53b remaining unchanged.

When the high-frequency treatment instrument 30 and the high-frequency supply cord 38 are repeatedly connected together before each operation, the movable terminal 44 moves a fixed distance each time to reduce the resistance value between the read terminals 53a and 53b in proportion to the number of connections (an experience-on-usage storage function). Once the movable terminal 44 has reached an end point of the electric resistor 43, it comes in abutment with the stopper projection 52 of the electric resistor 43 and is hindered from further movement.

In this state, the resistance value between the read terminals 53a and 53b is lowest. Since the projections 47 are made of rubber, a fixed or larger amount of force enables the end of the switch 43 to deform the projections 47 and climb over them. This prevents the movable terminal 44 from failing to push the switch operating rod 42 through it has reached the end point of the electric resistor 43, the failure hindering the connection of the high-frequency supply cord 38.

(Effects)

According to this embodiment, the value in proportion to the number of connections is retained to allow the determination of the number of times that the treatment instrument has been used (experience on usage).

### Second Variation of the Second Embodiment

An energy treatment system with an experience-on-usage storage function according to a second variation of the second embodiment will be described with reference to FIG. 16.

(Configuration)

This variation relates to the high-frequency treatment instrument 30 as described in the second embodiment, wherein the sheath 31, the hand-held section 32, treatment section 33, the gripping handle 34, the operation handle 35, the count section 36, the high-frequency electrode 37, and other components are configured in the same manner as those in the second embodiment. In this embodiment, the count section 36 is counted up each time the operation handle 35 is movably operated.

That is, the switch operating rod (slide rod) 42 for operating the count section 36 is slidably provided in the hand-held section 32 so as to slide in connection of the movement of the operation handle 35 to activate the count section 36 when the operation handle 35 is operated.

(Operation)

In operation, when the operation handle 35 is gripped to grip a tissue, the switch operating rod 42 is pushed to push the projections 47 on the belt 45 to rotate the belt 45. The rotation of the belt 45 moves the movable terminal 44 rightward in FIG. 15. Then, the resistance value between the read terminals 53a and 53b increases consistently with the amount that the movable terminal 44 has moved.

Returning the operation handle 35 does not move the belt 45 because the pulleys 46 do not rotate reversely. As a result, the removable terminal 44 is held at the position to which it has been moved, with the resistance value between the read terminals 53a and 53b remaining unchanged.

When tissues are repeatedly gripped, the movable terminal 44 moves a fixed distance each time to increase the resistance value between the read terminals 53a and 53b in proportion to the number of operations. Once the movable terminal 44 has reached the end point of the electric resistor 43, it comes in abutment with the stopper projection 52 of the electric resistor 43 and is hindered from further movement. In this state, the electric resistance between the read terminals 53a and 53b is highest.

Since the projections 47 are made of rubber, a fixed or larger amount of force allows the switch operating rod 42 to climb over the projections 47. This prevents an operator from failing to sufficiently grip the operation handle 35 through the movable terminal 44 has reached the end point of the electric resistor 43.

(Effects)

According to this embodiment, the value in proportion to the number of operations for the treatment is retained to allow the determination of the number of times that the treatment instrument has been used (experience on usage).

Although the high-frequency treatment instrument has been shown, the treatment instrument may not be for high frequency treatments as long as it has a movable operation handle.

### Third Variation of the Second Embodiment

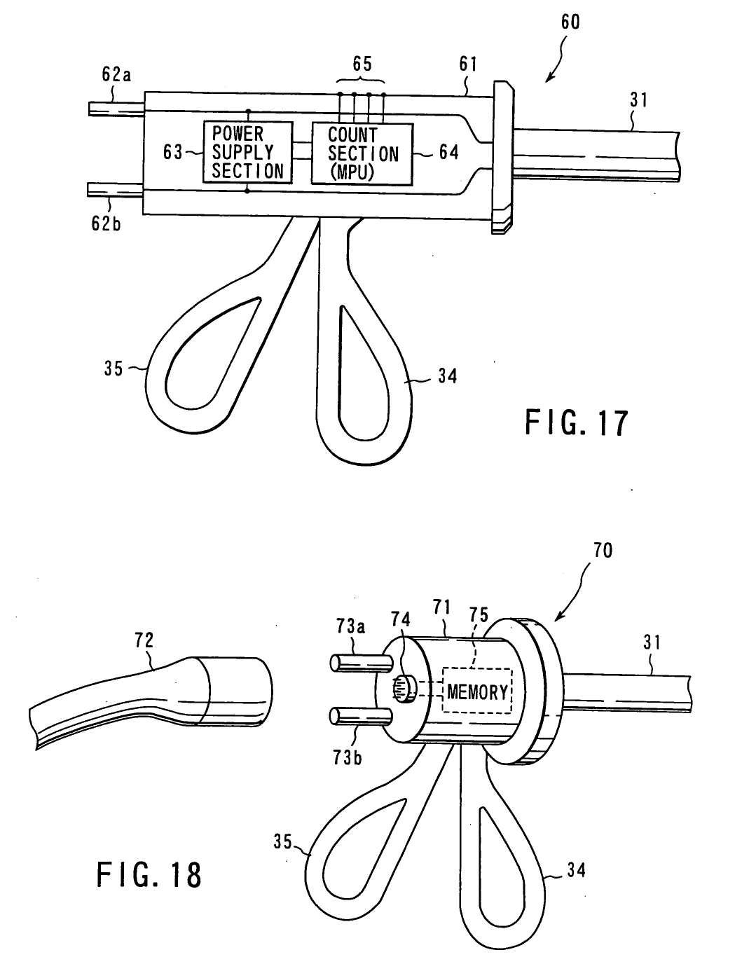

An energy treatment system with an experience-on-usage storage function according to a third variation of the second embodiment will be described with reference to FIG. 17.

(Configuration)

This variation also relates to the high-frequency treatment instrument 60. A hand-held gripping section 61 of the high-frequency treatment instrument 60 has a pair of high-frequency connection terminals 62a and 62b projected from a rear end thereof and to which high-frequency power supply cords (not shown) are connected. The hand-held gripping section 61 internally has a power supply section 63 for generating a DC voltage from a high frequency and a memory built-in count section 64. The power supply section 63 has an output end connected to the memory built-in count section 64. The hand-held gripping section 61 has a read section 65 on an external surface portion thereof. A value in a memory of the memory built-in count section 64 is output to the read section 65 as a binary number.

The other part of the configuration of the high-frequency treatment instrument is similar to that of the above described first or second embodiment.

(Operation)

When a high frequency is conducted through the high-frequency treatment instrument 60 for high-frequency coagulation or incision, a DC voltage is output from the power supply section 63 for a predetermined amount of time. The DC voltage activates the memory built-in section 64 to increment an output count number by one upon each activation. The number of previous outputs can be determined by reading the value in the read section 65.

(Effects)

This variation allows the number of electric connections through the treatment instrument 60 to be determined to more accurately determine the number of times that the treatment instrument 60 has been used.

### Fourth Variation of the Second Embodiment

An energy treatment system with an experience-on-usage storage function according to a fourth variation of the second embodiment will be described with reference to FIG. 18.

(Configuration)

This variation also relates to a high-frequency treatment instrument 70. A hand-held gripping section 71 of the high-frequency treatment instrument 70 has high-frequency connection terminals 73a and 73b projected from a rear end thereof and to which high-frequency power supply cords 72 with memory access lines are connected. Further, the hand-held gripping section 71 has a memory interface connector 74 at a rear end thereof. The memory interface connector 74 has a signal line connected to a memory 75 provided inside the hand-held gripping section 71.

The other part of the configuration of the high-frequency treatment instrument is similar to that of the above described embodiments.

(Operation)

To operate the high-frequency treatment instrument 70, the high-frequency power supply cords 72 with memory access lines are connected to the high-frequency connection terminals 73a and 73b. This enables a high-frequency power supply (not shown) to supply high-frequency energy for treatment to the high-frequency treatment instrument 70 via the high-frequency connection terminals 73a and 73b. Further, a signal from an apparatus main body (not shown) is communicated to the memory 75 through the memory access lines and via the memory interface connector 74 so that the number of times that the high-frequency treatment instrument 70 has been used or the amount of time for which it has been used is stored in the memory 75. For example, the number of outputs can be accumulated and stored upon each output. Alternatively, the amount of time for which high-frequency energy has been output can be accumulated and stored. Then, that the life of the high-frequency treatment instrument 70 is nearly over can be determined from the number of previous operations or the amount of operation time stored in the memory 75.

In addition, if the high-frequency treatment instrument 70 is connected to the apparatus main body (not shown) via the high-frequency power supply cords 72 with memory access lines, the apparatus main body may arbitrarily rewrite the contents of the memory 75 in the high-frequency treatment instrument 70. Alternatively, the apparatus main body can, for example, accumulate and store the number of outputs upon each output.

In addition, the contents of the memory 75 can be displayed on the apparatus main body to inform the user that the life of the high-frequency treatment instrument 70 is nearly over.

(Effects)

This variation enables arbitrary information on the experience on usage of the high-frequency treatment instrument 70 to be stored in the high-frequency treatment instrument 70 to inform the user that the life of the high-frequency treatment instrument 70 is nearly over.

Although the high-frequency treatment instrument has been illustrated, the present invention is not limited to this treatment instrument.

### Fifth Variation of the Second Embodiment

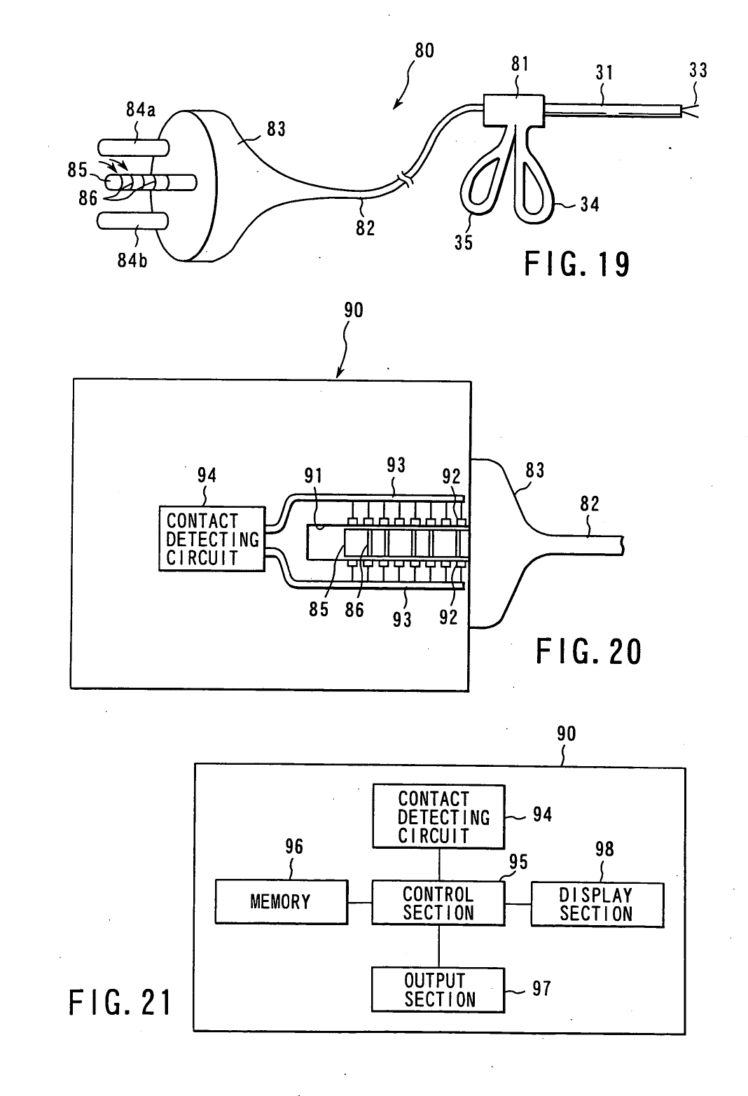

An energy treatment system with an experience-on-usage storage function according to a fifth variation of the second embodiment will be described with reference to FIGS. 19 to 21.

(Configuration)

This variation also relates to a high-frequency treatment instrument 80. As shown in FIG. 19, a hand-held gripping section 81 of the high-frequency treatment instrument 80 has a flexible cable 82 connected to a rear end thereof, and the cable 82 has a high-frequency connector 83 provided at an extended end thereof. FIG. 19 shows the portion of the high-frequency connector 83 in an enlarged view.

The high-frequency connector 83 has a pair of high-frequency connection terminals 84a and 84b and an ID pin 85 for identifying an individual. The ID pin 85 is made of a electrically insulated material and has annular metallic identifying terminals 86 on a surface thereof. The illustrated identifying terminals 86 are positioned so that up to eight such terminals are arranged at equal intervals. The ID of the high-frequency treatment instrument 80 is represented by a binary number based on the number and arrangement of the identifying terminals 86.

The high-frequency connector 83 of the high-frequency treatment instrument 80 is connected to an apparatus main body 90 as shown in FIG. 20. The apparatus main body 90 has an ID pin hole 91 into which the ID pin 85 of the high-frequency connector 83 to be connected is inserted and which internally has a plurality of contacts 92 arranged at equal intervals in eight pairs in such a manner that the contacts 92 of each pair are mutually opposed.

The interval between the pairs is the same as that between any two of the eight identifying terminals 86 arranged on the ID pin 85 so that the contacts 92 are electrically connected to the identifying terminals 86. In addition, the contacts 92 are mutually electrically insulated and connected to a contact detecting circuit 94 via a multiconductor cable 93.

Additionally, as shown in FIG. 21, the apparatus main body internally has a control section 95, a memory 96, an output section 97, and a display section 98, in addition to the above described contact detecting circuit 94.

(Operation)

Before the high-frequency treatment instrument 80 is operated, when the high-frequency connector 83 is connected to the apparatus main body 90, the ID pin 85 advances into the ID pin hole 91 and only the identifying terminals 86 on the ID pin 85 are electrically connected to the contacts 92. Then, the contact detecting circuit 94 checks all the opposed pairs of contacts 92 for electric conduction to determine the ID of the connected high-frequency treatment instrument 80.

When the contact detecting circuit 94 outputs data in connection with an operation of the high-frequency treatment instrument 80, the control section 95 stores the experience on usage such as the output duration or the number of previous outputs in the memory 96 for each ID (the experience-on-usage storage function). At this point, if information has already been stored on the same ID, the experience on usage is added to the contents of the already stored information for storage. Additionally, the contents of the memory 96 can be arbitrarily displayed on a display section of the apparatus main body 90. This can inform the user of the experience on usage of the high-frequency treatment instrument or that its life is nearly over.

The high-frequency treatment instrument has been described, but apparently the present invention is not limited to this treatment instrument. The number of pairs of identification terminals 86 or of opposed pairs of contacts 92 may be increased or reduced.

(Effects)

This variation enables arbitrary information on the experience on usage of the treatment instrument to be stored and communicated to the user.

### Sixth Variation of the Second Embodiment

An energy treatment system with an experience-on-usage storage function according to a sixth variation of the second embodiment will be described with reference to FIG. 22.

(Configuration)

This variation relates to an ultrasonic treatment instrument 100 with a bar code comprising a hand-held section 101 and a sheath 102. The sheath 102 has a closable treatment section 103 at a tip thereof. The hand-held section 101 has a fixed handle 104 and a movable handle 105. The movable handle 105 can be operated to open or close the treatment section 103. The hand-held section 101 has a bar code 106 on an external surface indicating the type or ID number of the ultrasonic treatment instrument 100.

The hand-held section 101 has a connection code 107 connected thereto. The connection code 107 is connected to an apparatus main body 110 also acting as a power supply.

A front surface of the apparatus main body 110 has a connection port 111 to which a connector of the connection code 107 is connected, a bar code reading section 112, and a display section 113. The apparatus main body also has a memory (not shown) inside; the contents stored in this memory can be displayed on the display section 113.

(Operation)

To operate the ultrasonic treatment instrument 100, before starting outputs, the bar code 106 is applied to the bar code reading section 112 to register the ultrasonic treatment instrument 100 used.

Whenever the ultraviolet treatment instrument 100 is used, its operation is detected so that the experience on usage such as the output duration or the number of previous outputs is stored in a memory (not shown) inside the main apparatus main body 110 for each ID of the ultrasonic treatment instrument 100. At this point, if information has already been stored on the same ID, the experience on usage is added to the contents of the already stored information for storage. Additionally, the contents of this memory can be arbitrarily displayed on the display section 113 to inform the user that the life of the ultrasonic treatment instrument 100 is nearly over.

The ultrasonic treatment instrument has been described, but apparently the present invention is not limited to this treatment instrument.

(Effects)

This variation enables arbitrary information on the experience on usage of the treatment instrument to be stored and communicated to the user, as in the above described fifth variation.

### Seventh Variation of the Second Embodiment

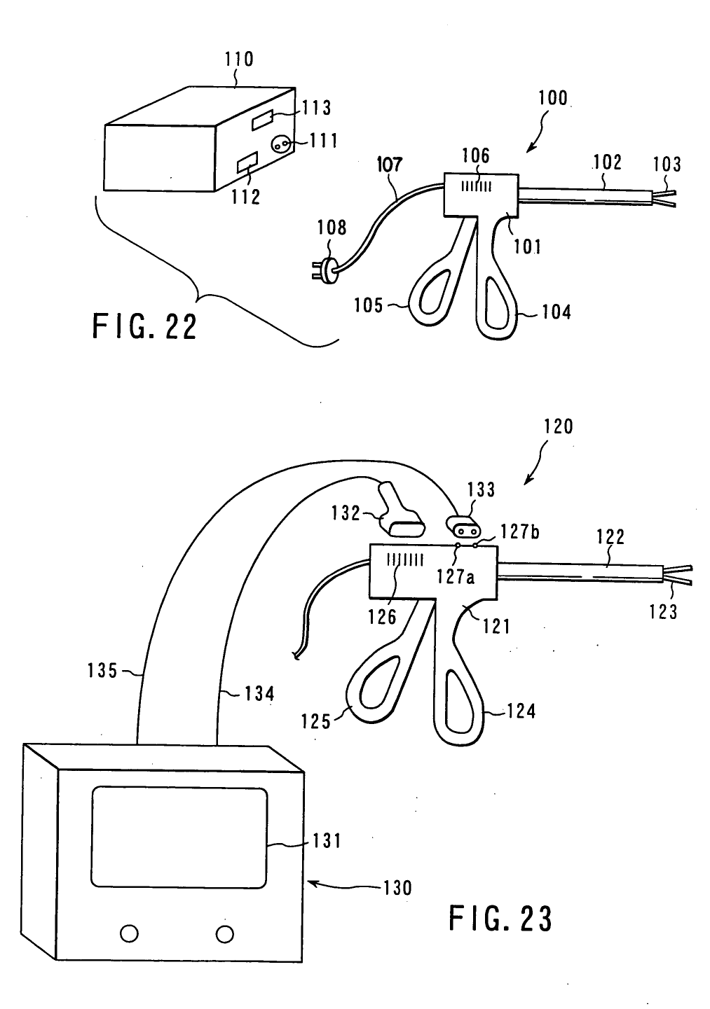

An energy treatment system with an experience-on-usage storage function according to a seventh variation of the second embodiment will be described with reference to FIG. 23.

(Configuration)

The seventh variation relates to an ultrasonic treatment instrument 120 with a bar code. Similarly to the above described ultrasonic treatment instrument, this treatment function comprises a hand-held section 121 and a sheath 122 having a closable treatment section 123 at a tip thereof. The hand-held section 121 has a fixed handle 124 and a movable handle 125. The movable handle 125 can be operated to open or close the treatment section 123.

The hand-held section 121 has, on its external surface, a bar code 126 indicating the type or ID number of the ultrasonic treatment instrument 100 and read terminals 127a and 127b through which a value that varies with the number of times that the ultrasonic treatment instrument 120 has been used can be read using a portable treatment instrument checking device, described later. A mechanism integrated with the ultrasonic treatment instrument to store and hold the number of previous operations may be any one of the mechanisms according to the above described embodiments from the second embodiment to the third variations thereof.

According to this variation, the portable treatment instrument checking device 130 is provided separately from the ultrasonic treatment instrument 120. The portable treatment instrument checking device 130 has a display panel 131 and a bar code reader 132 and a read connector 133 connected thereto via cables 134 and 135, respectively. The main body of the portable treatment instrument checking device 130 stores information on various treatment instruments.

(Operation)

The portable treatment instrument checking device 130 is activated, and the bar code 126 of the ultrasonic treatment instrument 120 is read using the bar code reader 132. The read type of the ultrasonic treatment instrument 120 is displayed on the display panel 131. Next, the read connector 133 is connected to the read terminals 127a and 127b. Then, the number of previous operations is displayed on the display panel 131, and the percentage of the displayed number with respect to a specified number of operations is also shown depending on the type of the ultrasonic treatment instrument 120 recognized from the bar code 126.

Although the ultrasonic treatment instrument has been illustrated, the present invention is not limited to this treatment instrument.

(Effects)

This variation enables the user to easily determined when to replace the treatment instrument. Since the treatment instrument checking device is portable, this variation is also effective when service personnel conduct maintenance work.

(Eighth Variation of the Second Embodiment)

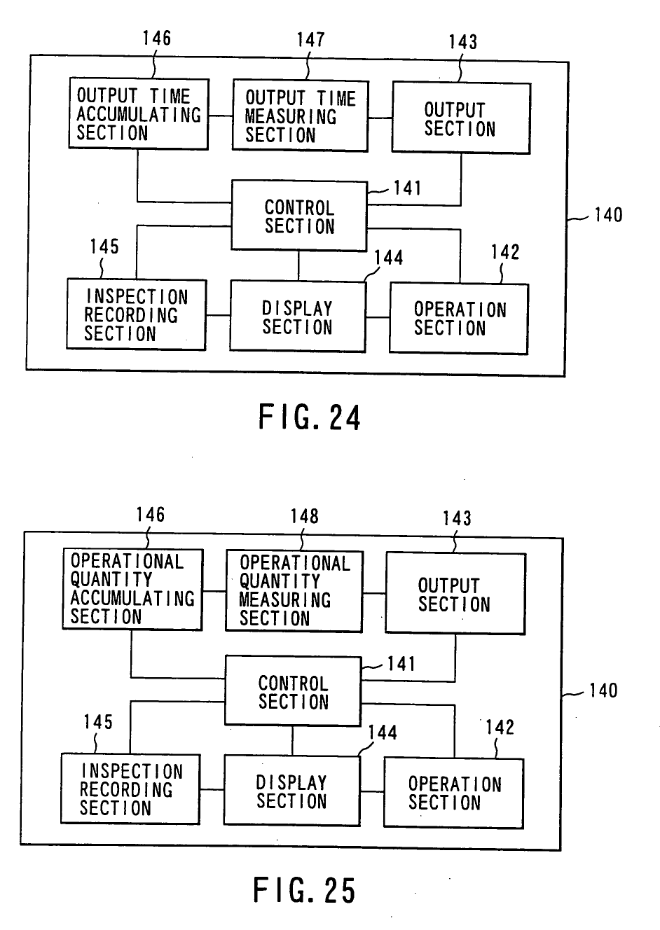

An energy treatment system with an experience-on-usage storage function according to an eighth variation of the second embodiment will be described with reference to FIG. 24.

(Configuration)

FIG. 13 is a block diagram of a main body 140 of a treatment system. The main body 140 belongs to, for example, an electric scalpel, an ultrasonic operating apparatus, a high-frequency treatment apparatus, a microwave treatment apparatus, or a hyperthermia apparatus and is not particularly limited.

The main body 140 has a control section 141, and an operation section 142, an output section 143, a display section 144, an inspection recording section 145, and an output duration (usage quantity) accumulating section 146 which are all linked to the control section 141. The inspection recording section 145 records the last inspection date and has a date managing function to allow the user to determine how many days have passed since the recorded inspection date. The inspection recording section 145 and the output duration accumulating section 146 each have a built-in memory that holds contents even after the power supply has been turned off so that an output duration measured by the output duration measuring section 147 is accumulatively recorded.

(Operation)

When the user operates the operation section 142, the output section 143 provides a required output. The output duration is measured by the output duration measuring section 147 and an accumulated duration is recorded in the output duration accumulating section 146. If the accumulated output duration exceeds a predetermined value, for example, 10 hours, the control section 141 uses a display function such as a LED on the display section 144 to inform the user of a recommended inspection period. Alternatively, if a predetermined number of days, for example, 365 days have passed since the last inspection date recorded in the inspection recording section 145, the control section 141 uses the display function such as a LED on the display section 144 to inform the user of a recommended inspection period.

Whatever condition has triggered the display of the recommended inspection, the apparatus can be used as usual without affecting the original functions.

If the apparatus has been inspected, the new inspection date is recorded in the inspection recording section 145 and the accumulated duration in the output duration accumulating section 146 is cleared to zero.

(Effects)

This variation can notify the user of an appropriate inspection period depending on the usage status based on the output experience or the number of days passed. In addition, since no error has occurred, the apparatus can be normally used despite the notification and inspected so as not to disturb the user's operation schedule.

### Ninth Variation of the Second Embodiment

An energy treatment system with an experience-on-usage storage function according to a ninth variation of the second embodiment will be described with reference to FIG. 25.

(Configuration)

FIG. 25 is a block diagram of the main body 140 of a treatment system. The main body 140 belongs to, for example, an electric scalpel, an ultrasonic operating apparatus, a high-frequency treatment apparatus, a microwave treatment apparatus, or a hyperthermia apparatus and is not particularly limited.

The main body 140 has the control section 141, and the operation section 142, the output section 143, the display section 144, the inspection recording section 145, and the usage quantity (output duration) accumulating section 146 which are all linked to the control section 141.

The inspection recording section 145 and the output duration accumulating section 146 each have a built-in memory that holds contents even after the power supply has been turned off. The inspection recording section 145 records the last inspection date and has a date managing function to allow the user to determine how many days have passed since the recorded inspection date. In addition, the usage quantity accumulation section 146 accumulatively records usage quantities measured by the usage quantity measuring section 148.

(Operation)

When the user operates the operation section 142, the output section 143 provides a required output. At this point, the usage quantity measuring section 148 calculates a usage quantity using output parameters such as a set power, a set temperature, and an output mode as well as the output duration, based on a predetermined function. For example:
(1) Usage quantity=set power×output duration
(2) Usage quantity=2×(set temperature−37)×output duration
(3) Usage quantity=output mode No.×output duration

The calculated usage quantity is recorded in the usage quantity accumulating section 146. If the accumulated usage quantity exceeds a predetermined value, the control section 141 uses the display function such as a LED on the display section 144 to inform the user of a recommended inspection period. Alternatively, if a predetermined number of days, for example, 365 days have passed since the last inspection date recorded in the inspection recording section 145, the control section 141 uses the display function such as a LED on the display section 144 to inform the user of a recommended inspection period.

Whatever condition has triggered the display of the recommended inspection, the apparatus can be used as usual without affecting the original functions.

If the apparatus has been inspected, the new inspection date is recorded in the inspection recording section 145 and the accumulated usage quantity in the usage quantity accumulating section 146 is cleared to zero.

(Effects)

This variation enables weighting based on the output conditions with the characteristics of the apparatus taken into account to notify the user of an appropriate inspection period depending on the usage conditions.

The above described second embodiment solves the problem with the prior art that the previous experience on usage is unknown when the apparatus fails, and enables the user to replace the treatment instrument with a new one at an optimal time before a trouble occurs.

That is, possible troubles can be reduced by storing the number of times that the treatment instrument has been used to determine that the specified usage quantity has been reached and checking the usage quantity of the treatment instrument to replace it with a new one at a replacement time. This enables provision of a medical apparatus compatible with the medical apparatus lease system.

Supplementary Note

(1) An energy treatment system having a switch operating in connection with an operation for assembling a treatment instrument and a count section holding a value proportional with the number of operations of the switch.

(2) An energy treatment system having a switch operating in connection with an operation for connecting a treatment instrument and a count section holding a value proportional with the number of operations of the switch.

(3) An energy treatment system having a switch operating in connection with an operation of a treatment instrument and a count section holding a value proportional with the number of operations of the switch.

(4) An energy treatment system having a signal generating section operating in connection with electric conduction through a treatment instrument and a count section for holding the accumulated number of signals generated.

(5) An energy treatment system set forth in (1) to (4), wherein the count section is located in the treatment instrument and the energy treatment system has a read section for reading a value for the count section.

(6) An energy treatment system having a memory located in the treatment instrument to store information, and a recording section for recording information in the memory.

(7) An energy treatment system set forth in (6), characterized in that the recorded information relates to experience on usage.

(8) An energy treatment system having an individual identifier located in a treatment instrument, an individual recognizing section for recognizing the individual identifier, and a recording section for recording experience on usage for each recognized individual identifier.

(9) An energy treatment system set forth in (7) and (8) having a notification section for notifying a user when the experience on usage exceeds a certain value.

(10) An energy treatment apparatus having a time measuring section for measuring an output duration, a time accumulating section for accumulating and holding the measured output duration, and a notification section for notifying a user that the accumulated duration has exceeded a certain value.

(11) An energy treatment apparatus having a time measuring section for measuring an output duration, a calculation section for calculating a usage quantity using the measured output duration and output parameters, based on a predetermined function, an accumulation section for accumulating and holding the calculated usage quantity, and a notification section for notifying a user that the accumulated usage quantity has exceeded a certain value.

(12) An energy treatment apparatus having an inspection recording section for recording the last inspection date and time and a notification section for notifying a user that a fixed period of time has passed since the date and time in the inspection recording section.

(13) An energy treatment apparatus set forth in (12) having the function in (10) or (11).

(14) An energy treatment apparatus set forth in (10) to (13), wherein an operation of the notification section does not affect an energy treatment function.

(15) An energy treatment system with an experience-on-usage storage function having a usage detecting section operating in connection with usage of a treatment instrument and a count section for holding a value proportional with the quantity of operations of the usage detecting section.

(16) An energy treatment system with an experience-on-usage storage function set forth in (15), characterized in that the count section is located in the treatment section and a read section for obtaining a value from the count section is located in an apparatus main body.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A medical apparatus comprising:
a usage detecting section which operates in connection with an operation of a medical device; and
a counting section which stores a value corresponding to a number of operations of the usage detecting section.

2. The medical apparatus according to claim 1, wherein the usage detecting section comprises a switch which operates in connection with an operation of connecting the medical device to a main body of the medical apparatus; and
wherein the counting section stores a value corresponding to a number of operations of the switch.

3. The medical apparatus according to claim 1, wherein the usage detecting section comprises a switch which operates in connection with an operation the medical device; and
wherein the counting section stores a value corresponding to a number of operations of the switch.

4. The medical apparatus according to claim 1, wherein the usage detecting section comprises a signal generating section which generates a signal in connection with an electric conduction operation through the medical device; and
wherein the counting section stores a value corresponding to a number of signals generated by the signal generating section.

5. The medical apparatus according to claim 1, further comprising:
an individual identifier provided in the medical device for identifying the medical device;
a recognizing section for recognizing the individual identifier; and
a recording section for recording usage data corresponding to each recognized individual identifier.
